(19) United States
(12) Patent Application Publication
(10) Pub. No.: US 2013/0247576 A1
(43) Pub. Date: Sep. 26, 2013

(54) APPARATUS, SYSTEM AND METHOD FOR OBSERVING COMBUSTOR FLAMES IN A GAS TURBINE ENGINE

(71) Applicants: Douglas C. MYHRE, Eden Prairie, MN (US); Joseph R. Michel, St. Paul, MN (US); Jerry L. Goeke, West Des Moines, IA (US); Timothy Aadland, Lakeville, MN (US); Nicholas R. Overman, West Des Moines, IA (US)

(72) Inventors: Douglas C. MYHRE, Eden Prairie, MN (US); Joseph R. Michel, St. Paul, MN (US); Jerry L. Goeke, West Des Moines, IA (US); Timothy Aadland, Lakeville, MN (US); Nicholas R. Overman, West Des Moines, IA (US)

(73) Assignees: DELAVAN INC, West Des Moines, IA (US); ROSEMOUNT AEROSPACE INC., Burnsville, MN (US)

(21) Appl. No.: 13/428,330

(22) Filed: Mar. 23, 2012

(51) Int. Cl. F02C 7/22; F02C 7/00; G01M 15/00; F23R 3/28

(52) U.S. Cl. 60/772; 60/740; 60/803; 73/112.01

(57) ABSTRACT

A fuel injector for a gas turbine engine is disclosed which includes a nozzle body for issuing fuel and air into a combustor, and an on-axis optical probe located within the nozzle body for observing combustor flame radiation, wherein the optical probe includes a plurality of optical fiber bundles extending to a distal end of the probe, and a shaped lens is supported at the distal end of the probe to provide a multi-directional field of view of combustion characteristics and properties in an operating gas turbine engine combustor.

### BACKGROUND OF THE INVENTION

1. Field of the Invention

The subject invention is directed to optical sensors for gas turbine engines, and more particularly, to an apparatus, system and method for observing the characteristics of a moving flame in the combustion chamber of a gas turbine engine to detect, in real-time, conditions indicative of combustion instabilities and the like.

2. Background of the Related Art

Combustion instability is a significant problem in the design of low-emission, high performing combustion chambers for gas turbines, boilers, heaters and furnaces. Combustion instability is generally understood as high amplitude pressure oscillations that occur as a result of the turbulent nature of a combustion process and the large volumetric energy release within the combustion chamber. Combustion instability diminishes engine system performance, and the vibrations resulting from pressure oscillations can damage hardware components, including the combustion chamber.

There are many factors that contribute to combustion instability within the combustion chamber of a gas turbine. These include, for example, the fuel content, fuel and/or air injection speed or inlet pressure, fuel/air concentration/ratio, temperature changes within the combustion chamber, the stability of the flame, large scale coherent flow structures affecting mixing (i.e., vortex shedding), the coupling of acoustic pressure waves with combustion heat release at combustor resonance frequencies, and/or extinction/re-ignition phenomenon occurring at low flame temperature and high combustion pressure.

Passive control methods have been employed to correct combustion instability, including, for example, modifying the fuel injection distribution pattern, or changing the shape or capacity of the combustion chamber. Passive controls are often costly and limit combustor performance. More recently, active controls have been used to correct combustion instability by modifying the pressure within the system and/or regulating the flow of fuel or air into the combustor in response to detected unstable conditions. An example of an active combustion control system for gas turbine engines is disclosed in commonly assigned U.S. Pat. No. 7,775,052 to Cornwell et al., the disclosure of which is herein incorporated by reference in its entirety.

It has been determined through experimentation that direct observation of a combustor flame can provide information that may be used to actively control combustion instability. For example, combustion driven thermal oscillations can be detected by observing variations in flame intensity. In addition, spectral radiation indicative of combustion by-products and emissions that effect flame temperature or other flame qualities may be observed. These observations may be analyzed and used by an active combustion control system to regulate the flow of fuel to the combustion chamber of a gas turbine or adjust the fuel/air ratio for combustion and thereby stabilize the combustion process. Optical sensors for effectively observing combustion processes are disclosed in commonly assigned U.S. Pat. Nos. 7,334,413, 7,484,369 and 7,966,834 to Myhre.

It is well known that the primary combustion zone within the burner of a gas turbine engine is not stationary. That is, the flame front can move out of the field of vision of the flame sensor. This can cause the system to obtain inaccurate or inconsistent measurements, causing errors in the determination of the flame characteristics derived from chemiluminescent peaks, especially during extremes of throttle operation.

There is a need in the art for an optical flame sensor that may be used in active combustion control which overcomes the short comings of prior art optical flame sensing systems, with regard to the observation of a moving flame front. Moreover, there is a need in the art for an optical flame sensor that may be employed in the combustion chamber of a gas turbine engine, which can track a moving flame.

### SUMMARY OF THE INVENTION

The subject invention is directed to an apparatus for observing conditions within the combustion chamber of a gas turbine engine. More particularly, the subject invention is directed to a new and useful optical sensor for observing or otherwise tracking a moving combustor flame within the combustion chamber of a gas turbine engine to accurately control combustion, and thereby optimize engine efficiency.

The optical sensor of the subject invention includes a fuel injector having a nozzle body for issuing fuel and air into a combustor, and an optical probe located within the nozzle body along a central axis thereof for observing combustor flame radiation. The optical probe includes a plurality of optical fiber bundles extending to a distal end of the probe. A shaped lens is supported at the distal end of the probe and it is configured to provide a multi-directional field of view for the optical fiber bundles. Preferably, the shaped lens has a generally hemispherical configuration that provides a diverging view from each fiber bundle, and it is preferably formed from sapphire or a similar material.

In accordance with a preferred embodiment of the subject invention, each optical fiber bundle includes a plurality of optical fibers. The number of optical fibers in each optical fiber bundle can range from at least two fibers to as many as seven fibers or more depending upon the use of the probe, the size of the fiber and how the probe is adapted to or otherwise mounted within a particular fuel injector.

Preferably, the optical probe has at least seven optical fiber bundles arranged in such a mariner so that there is a central optical fiber bundle surrounded by six or more circumferentially arranged optical fiber bundles. In one embodiment of the subject invention, the surrounding fiber bundles are twisted or otherwise positioned around the central fiber bundle to reduce the overall diameter of the distal end portion of the optical probe and to enable the optical end surface at the end of each surrounding fiber bundles to be at an angle to the axis of the probe.

Each optical fiber bundle is supported within a respective heat resistant inner guide tube, and the plurality of inner guide tubes are enclosed within a heat resistant outer guide tube. The shaped lens is preferably supported within a heat resistant conically tapered lens housing mounted at a distal end of the outer guide tube. The shaped lens may be attached and sealed to the lens housing a platinum mounting sleeve in the manner described for example in U.S. Pat. No. 7,987,712 to Myhre et al., the disclosure of which is herein incorporated by reference in its entirety. Alternative mounting methods known in the art may also be readily employed.

The subject invention is also directed to a system for observing combustion conditions in a gas turbine engine which includes a nozzle body for issuing fuel into a combustor, an optical probe operatively associated with the nozzle body for observing radiation from combustion, and means for tracking movement of the flame within the combustor based upon observations by the optical probe. The means for tracking flame movement includes an array of fiber optic bundles within the optical probe for receiving flame radiation across a specific space.

The means for tracking flame movement further includes a detector communicating with the array of fiber optic bundles for detecting flame radiation received by the each of the fiber optic bundles, and a comparator for comparing the flame radiation detected by each of the fiber optic bundles, to determine which fiber optic bundle observed the greatest intensity of flame radiation within the combustion chamber. Once intensity distribution is determined, the flame data obtained from the optical detector that observed the greatest intensity of flame radiation is used to control combustion in the gas turbine engine. This may be done by actively modulating fuel flow through the fuel injector.

The subject invention is also directed to a method of controlling combustion in a gas turbine engine that includes the steps of detecting flame radiation received by a plurality of optical detectors located within the combustion chamber of a gas turbine engine, determining which of the plurality of optical detectors observed the greatest intensity of flame radiation within the combustion chamber, and selecting flame data obtained from the optical detector that observed the greatest intensity of flame radiation to control combustion in the gas turbine engine.

Preferably, the step of selecting data obtained from the optical detector that observed the greatest intensity of flame radiation includes selecting chemiluminescent spectral data from the optical detector, such as, for example, CH and/or OH chemiluminescent peak intensity, which can correlate to the air-fuel ratio characteristics of the flame. The method further includes the steps of tracking the position of a flame based upon a comparison of the intensity of flame radiation observed by each of the plurality of optical detectors, and utilizing the position of the flame as data for controlling combustion.

Those skilled in the art will also be cognizant of the usefulness of this invention for gas turbine and gas turbine combustor test rigs, and for use in gas turbine engine testing and diagnostic programs. In these cases the optical detector will provide valuable information regarding the location of the flame, thermal mixing of the flame constituents, the location of possible combustion hot spots that may adversely affect the turbine, or defects in the flame pattern. Indeed, the subject invention can be used to diagnose a defective fuel injector by using the optical probe to observe a combustor flame emanating from the fuel injector, and detecting a pattern of radiation within the combustor flame that is indicative of a defective fuel injector. In this regard, a detected pattern of relatively low or relatively high flame intensity could be the result of a clogged or partially clogged fuel injector.

These and other aspects of the apparatus, systems and methods of the subject invention will become more readily apparent to those having ordinary skill in the art from the following detailed description of the invention taken in conjunction with the drawings.

### BRIEF DESCRIPTION OF THE DRAWINGS

So that those having ordinary skill in the art to which the present invention pertains will more readily understand how to employ the novel apparatus, system and method of the present invention, embodiments thereof will be described in detail hereinbelow with reference to the drawings, wherein:

FIG. 1 is a perspective view of a fuel injector configured in accordance with a preferred embodiment of the subject invention which includes an optical sensing system for tracking a moving flame within a combustion chamber of a gas turbine engine;

FIG. 2 is an enlarged localized view of the nozzle body of the fuel injector shown in FIG. 1, which includes the on-axis optical probe of the subject invention;

FIG. 3 is an enlarged localized view of the interior of the nozzle assembly show in FIG. 2, illustrating the optical probe of the subject invention;

FIG. 4 is a cross-sectional view of the optical probe of the subject invention taken along line 4-4 of FIG. 3, illustrating the optical fiber bundles supported within the guide tube of the optical probe, and showing the configuration of the shaped lens;

FIG. 5 is a perspective view of the distal end portion of the optical probe, with the lens housing shown in cross-section to illustrate the configuration of the fiber bundles therein and showing the lens removed from the housing for ease of illustration;

FIG. 6 is a cross-sectional view of the optical probe of the subject invention taken along line 6-6 of FIG. 4, showing the arrangement of optical fiber bundles;

FIG. 7 is a is a perspective view of the nozzle body of the fuel injector of FIG. 1, which includes a graphical illustration depicting the field of view of the optical probe incorporated therein, which includes seven fiber bundles each having seven optical fibers for observing combustion conditions;

FIG. 8 is a perspective view of the nozzle body of the fuel injector of FIG. 1, which includes a graphical depiction of the field of view of an optical probe having seven fiber bundles each with five optical fibers for observing combustion conditions;

FIG. 9 is a perspective view of the nozzle body of the fuel injector of FIG. 1, which includes a graphical depiction of the field of view of an optical prober having seven fiber bundles each with two optical fibers for observing combustion conditions;

FIG. 10 is a perspective view of another embodiment of the optical probe of the subject invention, wherein the fiber bundles housed therein are axially twisted to provide a reduced tip diameter;

FIG. 11 is a cross-sectional view taken along line 11-11 of FIG. 10, showing the twisted end portion of the optical fiber bundles of the optical probe; and

FIG. 12 is an illustration of the reaction zone downstream from the nozzle body where axial and off-axis flame movement is detected as radiation intensity changes within the field of view of the fiber optic bundles that form the optical probe of the subject invention.

### DETAILED DESCRIPTION OF THE PREFERRED EMBODIMENTS

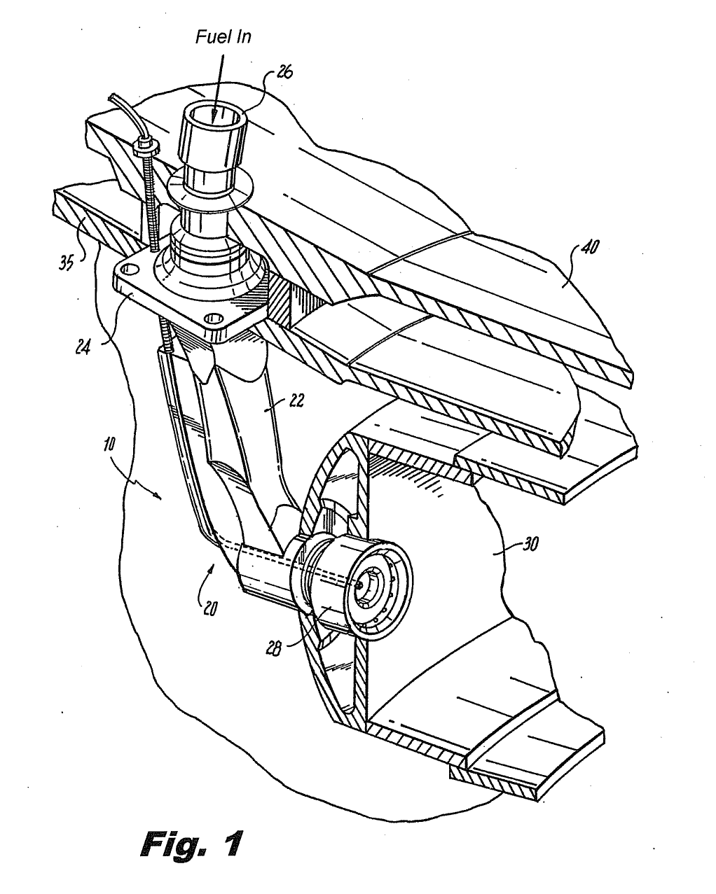

Referring now to the drawings wherein like reference numerals identify similar structural features or aspects of the subject invention, there is illustrated in FIG. 1 an optical sensing system for observing combustion conditions within the combustion chamber of a gas turbine engine for use in conjunction with an active combustion control system. The optical sensing system of the subject invention is designated generally by reference numeral 10.

Referring to FIG. 1, optical system 10 includes a fuel injector 20 mounted or otherwise supported within the combustion chamber 30 of gas turbine engine 40 in a conventional manner. More particularly, fuel injector 20 includes an elongated feed arm 22 having a support flange 24 for mounting the injector within the combustion chamber 30. The support flange 24 is particularly adapted to secure the injector to the interior liner 35 of the combustion chamber 30 using conventional fasteners.

The fuel injector 20 further includes an inlet port 26 for receiving fuel from a fuel pump at a commanded flow rate. A fuel modulation valve (not shown) is operatively associated with the inlet port 26 of fuel injector 20 for modulating the flow of fuel from the fuel pump to the fuel injector based upon combustion conditions observed by the optical sensing system 10 within the combustion chamber 30. Fuel modulation valves useful for this purpose are disclosed, for example, in commonly assigned U.S. Pat. No. 7,665,305 to Cornwell et al., the disclosure of which is herein incorporated by reference in its entirety.

A fuel nozzle or nozzle body 28 depends from the distal end of the feed arm 22 of fuel injector 20 to inject or otherwise issue atomized fuel into the combustion chamber 30 of gas turbine engine 40. The fuel injector 20 can take the form of a pressure atomizer or an air blast atomizer, depending upon the engine application. Accordingly, the configuration of the nozzle body 28 of fuel injector 10 can vary. Examples of fuel injectors having a nozzle body in the form of an airblast atomizer suitable for use with the optical system of the subject invention are disclosed for example in commonly assigned U.S. Pat. No. 7,779,636 to Buelow et al. and commonly assigned U.S. Pat. No. 7,926,744 to Thompson et al., the disclosures of which are herein incorporated by reference in their entireties.

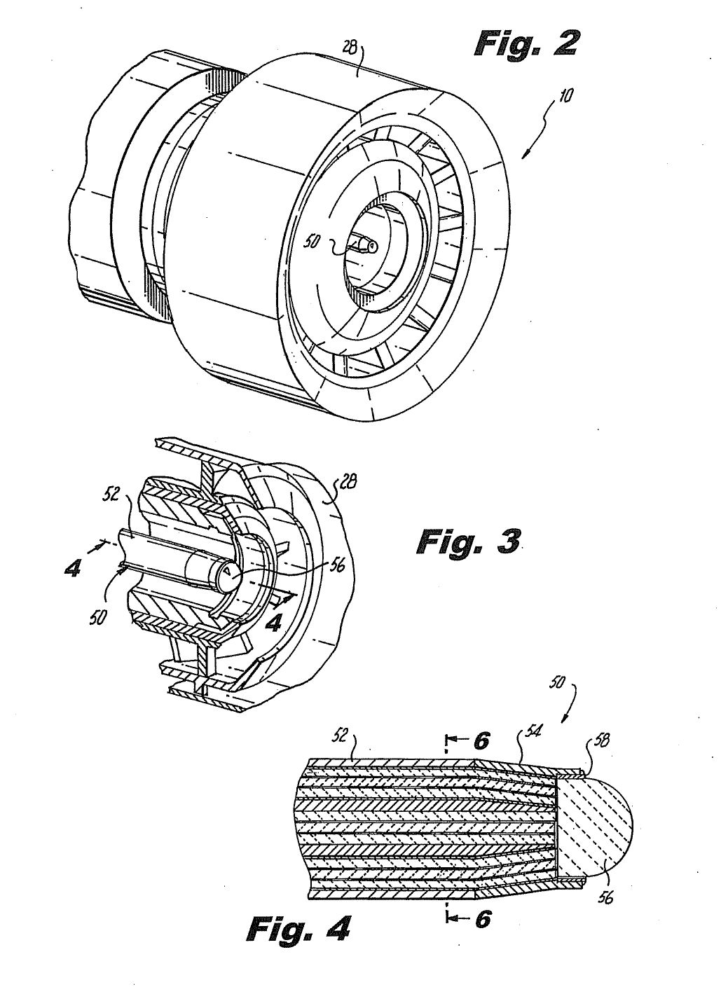

Referring now to FIGS. 2 and 3, in accordance with a preferred embodiment of the subject invention, the optical system 10 includes an elongated optical probe 50. The optical probe 50 is mounted in the nozzle body 28 using an appropriate fixture (not shown), and is preferably aligned with the central axis of the nozzle body 28 to effectively observe a moving combustor flame within the reaction zone of the combustion chamber 30. It is envisioned, that the optical probe 50 could be located in a different position within the nozzle body without departing from the spirit or scope of the subject disclosure. For example, commonly assigned U.S. Pat. No. 7,334,413 to Myhre describes optical sensors located within viewing ports formed in the leading edge of the outer air swirler of the nozzle body.

Referring to FIGS. 4 through 6, the optical probe 50 includes a heat resistant outer guide tube 52. An inwardly tapered conical lens housing 54 is provided at the distal end of outer guide tube 52 for supporting a bulb shaped viewing lens 56 having a generally hemi-spherical configuration designed to provide a broad multi-directional diverging field of view for effectively observing the combustor flame. The outer guide tube 52 and lens housing 54 of optical probe 50 are preferably formed from a super alloy such as, for example, a nickel chromium alloy material such as Inconel® or a similar heat resistant super alloy capable of withstanding the high temperature operating environment that exists within the combustion chamber of a gas turbine engine. These operating temperatures can exceed 500° C.

The shaped hemispherical lens 56 is formed from a heat resistant transparent material such a sapphire or the like. It is envisioned that the exposed outer surface of the viewing lens 56 would have a protective coating. For example, the lens 56 can have a vapor deposited layer comprising a mixture of platinum and aluminum oxide which acts as a catalyst to promote oxidation of soot to a gaseous form and thereby reduce contamination of the lens, as disclosed for example in U.S. Pat. No. 4,521,088 to Masom, the disclosure of which is incorporated herein by reference in its entirety.

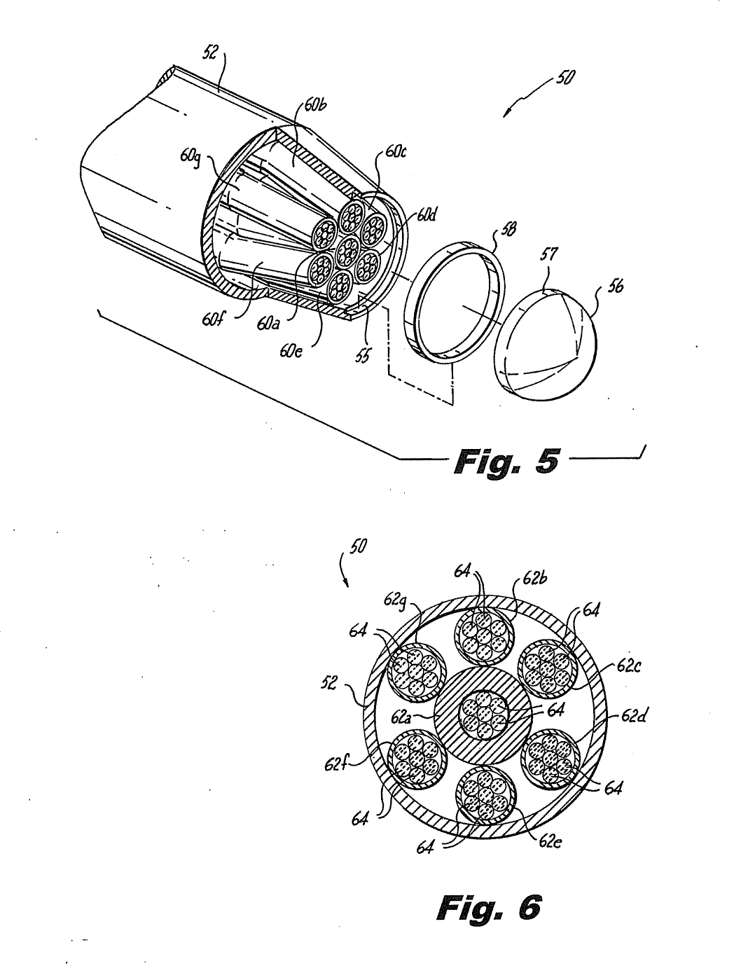

The lens 56 is preferably attached to the lens housing 54 using a platinum mounting sleeve 58 in the manner described for example in U.S. Pat. No. 7,987,712 to Myhre et al., the disclosure of which is herein incorporated by reference in its entirety. More particularly, the shaped lens 56 includes a proximal mounting section 57 having a cylindrical configuration. The platinum mounting sleeve 58 is positioned around the cylindrical mounting section 57 of the lens 56 and seated in a mounting recess 55 formed in the distal end of lens housing 54, which is best seen in FIG. 5. This mounting assembly facilitates the formation of a high temperature seal between the lens 56 and the lens housing 54, as disclosed in U.S. Pat. No. 7,987,712 to Myhre et al.

A plurality of optical fiber bundles are housed within the outer guide tube 52 and they extend to the distal end thereof to form an optical fiber array for viewing the combustor flame. More particularly, seven optical fiber bundles 60a-60g are housed within the outer guide tube 52 of optical probe 50, each for observing a different sector of the reaction zone within the combustion chamber 30. The seven fiber bundles include a central fiber bundle 60a and six circumferentially arranged surrounding fiber bundles 60b-60g. Each fiber bundle 60a-60g is supported within a respective heat resistant inner guide tube 62a-62g, which also preferably formed from a heat resistant material such as Inconel® or a similar super alloy. The inner and outer guide tubes may also be formed from stainless steel. It is also envisioned that the inner guide tubes 62a-62g could have platinum distal end portions while the remainder of the guide tubes would be formed from Inconel. As best seen in FIG. 5, the distal end portion of the central guide tube 62a is tapered to match the geometry of the tapered lens housing 54, and thereby accommodate a reduction in the diameter of the six guide tubes 62b-62g surrounding central guide tube 62a at the distal end of optical probe 50.

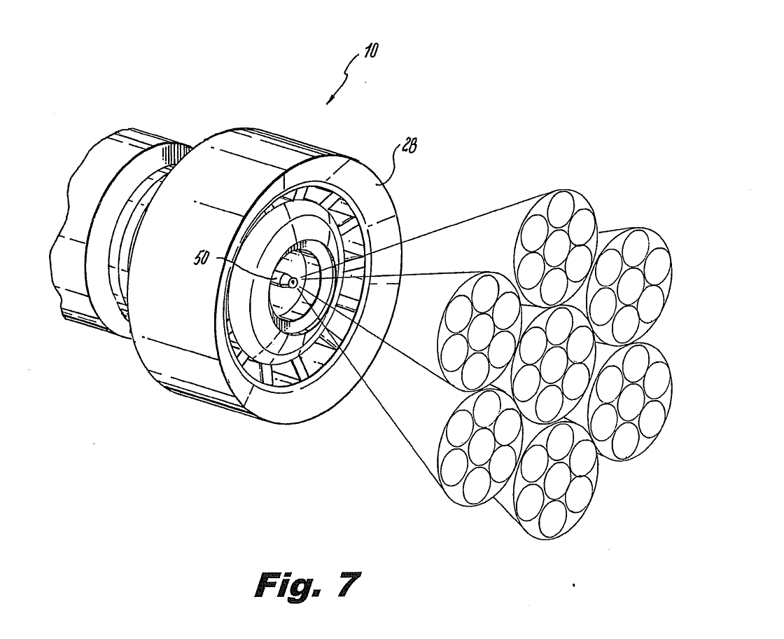

Each optical fiber bundle 60a-60g includes a plurality of optical fibers 64. The number of optical fibers in each optical fiber bundle can range from two fibers to seven fibers depending upon the use, size of the fiber and how it is adapted to a particular fuel injector. For example, FIGS. 6 and 7 illustrate an optical probe 50 constructed in accordance with one embodiment of the subject invention wherein each optical fiber bundle includes seven optical fibers 64 for observing combustion conditions.

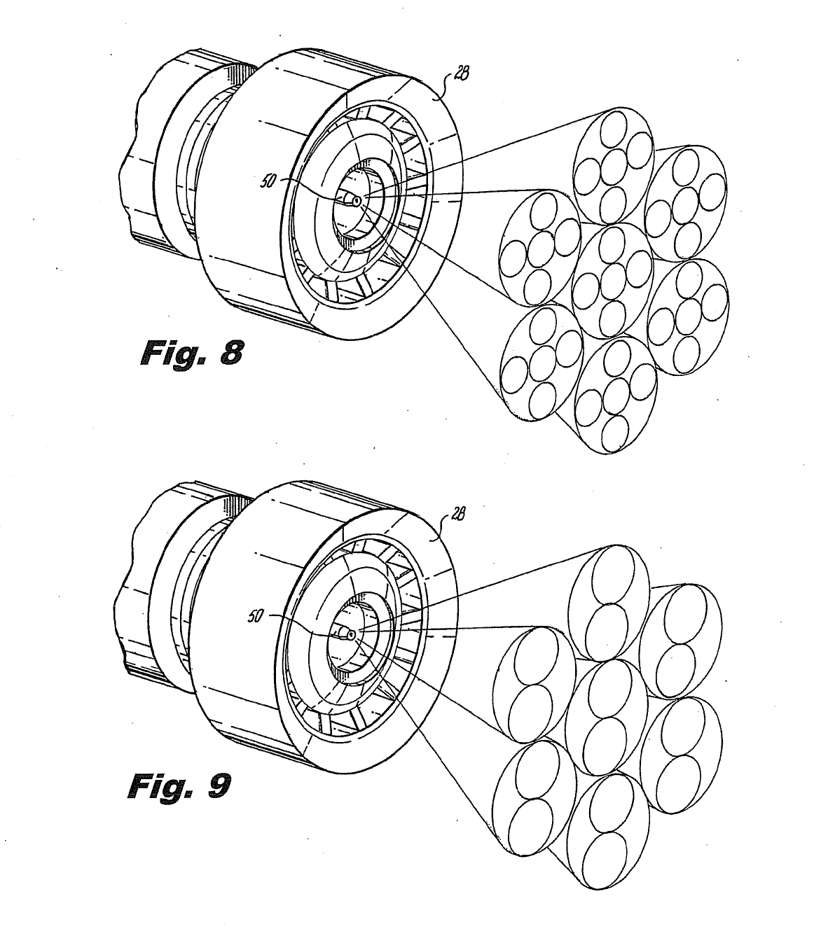

Alternatively, FIG. 8 illustrates an embodiment of the subject invention wherein each optical fiber bundle of the optical probe 50 includes five optical fibers 64, and FIG. 9 illustrates an embodiment of the subject wherein each optical fiber bundle of the optical probe 50 includes two optical fibers 64. In each configuration, the optical fiber bundles 60a-60g are arranged so that each fiber bundle observes a different sector of the reaction zone downstream from the nozzle body 28, providing an expansive field of view through the hemispherical viewing lens 56.

The optical fibers 64 forming each of the fiber bundles 60a-60g within optical probe 50 can consist of 100μ silica (UV enhanced) fibers or the like. The fibers 64 are preferably coated or otherwise treated to withstand the operating temperatures within the combustion chamber 30. For example, the optical fibers 64 may be provided with a coating, such as gold or a similar precious metal suited for thermal protection. One example would be gold-coated 200μ silica (UV enhanced) fibers rated to 700° C. Another example would be gold-coated 400μ silica (UV enhanced) fibers. Other coatings resistant to high temperatures may also be used.

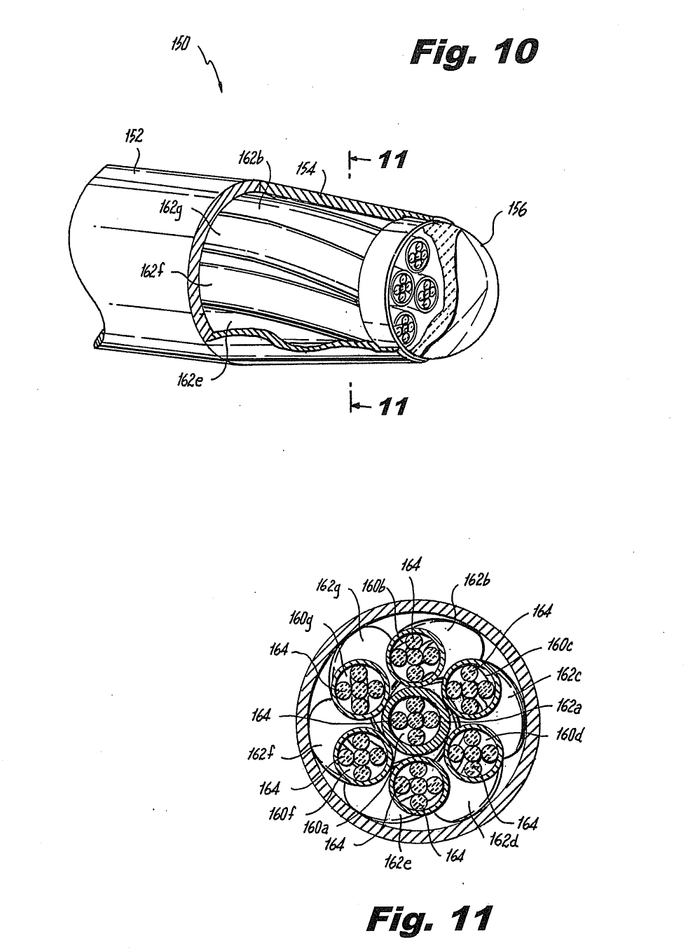

Referring now to FIGS. 10 and 11, there is illustrated another embodiment of the optical probe of the subject invention, which is designated generally by reference numeral 150. Optical probe 150 is substantially similar to the previously described optical probe 50 in that it includes an elongated outer guide tube 152, which houses a plurality of inner guide tube 162a-162g, each of which supports a respective optical fiber bundle 160a-160g that comprises a plurality of optical fibers 164 forming an optical array. Probe 150 further includes a tapered lens housing 154 and a generally hemi-spherical shaped viewing lens 156 sealingly mounted in the lens housing 154. The difference between probe 150 and probe 50, is that the distal end portion of the six fiber guide tubes 162b-162g that surround the central fiber guide tube 162a are axially twisted around the central fiber guide 162a to reduce the overall diameter of a distal end portion of the optical probe 150.

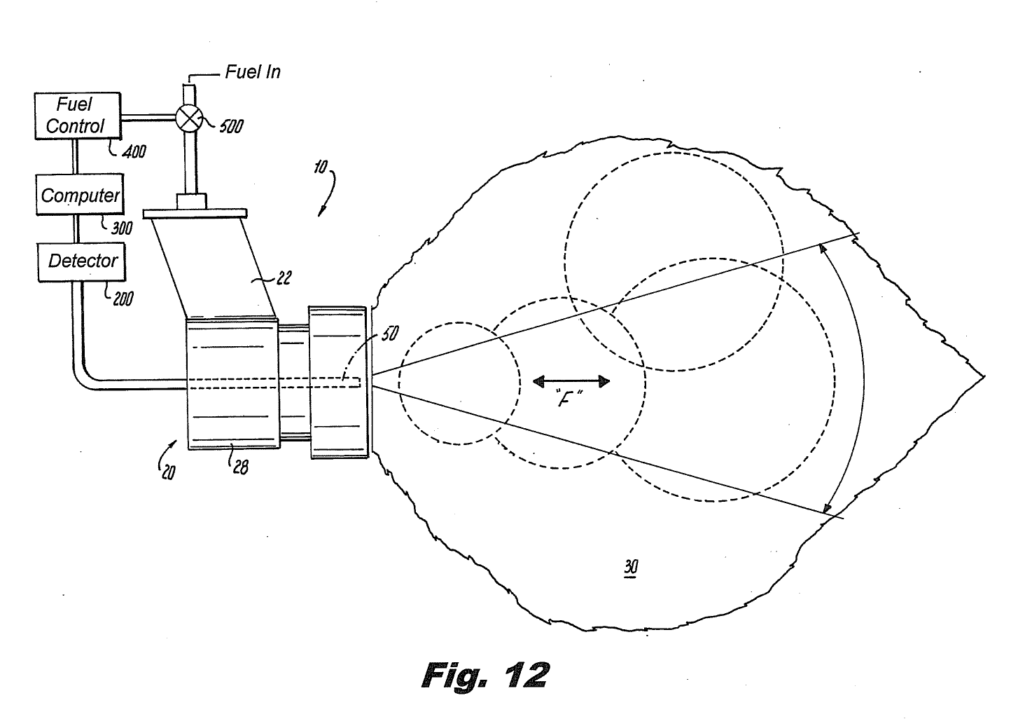

Referring to FIG. 12, in accordance with the subject invention, the optical probe 50, with its wide field of view, is particularly well adapted to track the movement of a flame “F” within the reaction zone of the combustion chamber 30. In accordance with the subject invention, the optical probe 50 is adapted and configured to track the movement of the flame “F” axially (i.e., traveling along the axis of the nozzle body) as well as angularly (i.e., at an angle to the axis of the nozzle body). To accomplish this task, each of the optical fiber bundles 62a-62g are fed to separate optical detectors 200 which detect the intensity of the flame radiation directly observed thereby. More particularly, the intensity of the flame is measured using the ratio of the OH and CH peaks of the spectral bands viewed by the optical fibers observing a certain sector of the reaction zone within the combustion chamber 30, since it has been shown that this ratio is directly related to temperature and therefore, the air-fuel ratio of a flame in an operating engine.

The output measurements from the detectors 200 are digitized, amplified and fed to a comparator/computer 300. The comparator 300 correlates the flame intensity measurements from the detectors 200 with the location of the flame within the combustor 30. That is, as the flame moves through the reaction zone, the radiation intercepted by the different fiber bundles 60a-60g in probe 50 is compared by the comparator 300, in real time. After the comparison is performed, the fiber bundle that receives the greatest OH/CH ratio value is electronically selected for use in fuel control, because this value is indicative of the most likely position of the flame within the reaction zone of the combustor. In doing so, the flame data used for active fuel control is less sensitive to the spatial movement of the flame as it is generated by the most intense region of the flame as it moves within the reaction zone of the combustor.

The selected flame data from the optical fiber bundle that observed the greatest flame intensity values may be used by an active control system 400 to actively modulate the flow of fuel to the inlet 26 of fuel injector 20 through a fuel modulation valve 500 to improve engine efficiency. For example, the data can be used to modulate the total amount of fuel sent to the fuel injector or the fuel split between primary, secondary or possibly tertiary fuel circuits within the fuel injector to maintain optimal engine performance.

In an alternative method of tracking flame movement within a specific space, it is envisioned that individual optical fibers from a single optical fiber bundle could be split so that some of the fibers in the bundle would be sent to a first spectral peak detector/amplifier and other fibers in the bundle would be sent to another spectral peak detector/amplifier. The outputs of the detectors/amplifiers for each split fiber bundle would be digitized and compared algorithmically to determine certain characteristics of a particular region of the combustor flame.

Those skilled in the art should recognize that there are other ways in which the flame data obtained by the optical fiber bundles can be utilized to optimize engine performance or otherwise improve the operability of a gas turbine engine, aside from tracking a moving flame within a combustor. For example, it is envisioned that the data can be used diagnostically to detect a defect in the flame pattern (i.e., a pattern of high or low flame intensity) that may be a result of a clogged or partially clogged fuel injector.

Although the apparatus, system and method of the subject invention have been described with respect to preferred embodiments, those skilled in the art will readily appreciate that changes and modifications may be made thereto without departing from the spirit and scope of the subject invention as defined by the appended claims.

What is claimed is:

1. A fuel injector for a gas turbine engine comprising:
a) a nozzle body for issuing fuel and air into a combustor;
b) an optical probe located within the nozzle body for observing combustor flame radiation, the optical probe including a plurality of optical fiber bundles extending to a distal end of the probe; and
c) a shaped lens supported at the distal end of the probe and configured to provide a multi-directional field of view for the optical fiber bundles to observe multiple regions of the combustor.

2. A fuel injector as recited in claim 1, wherein each optical fiber bundle includes a plurality of optical fibers.

3. A fuel injector as recited in claim 2, wherein each optical fiber bundle has at least two optical fibers.

4. A fuel injector as recited in claim 1, wherein the optical probe has at least seven optical fiber bundles.

5. A fuel injector as recited in claim 4, wherein the optical probe includes a central optical fiber bundle surrounded by at least six circumferentially arranged optical fiber bundles.

6. A fuel injector as recited in claim 5, wherein the surrounding fiber bundles are placed around the central fiber bundle in such a manner so that an optical end surface of each fiber bundle is disposed at an angle to an axis of the central fiber bundle.

7. A fuel injector as recited in claim 1, wherein the shaped lens provides a diverging view from each fiber bundle.

8. A fuel injector as recited in claim 1, wherein the shaped lens is formed from sapphire.

9. A fuel injector as recited in claim 1, wherein the nozzle body has a central axis and the optical probe is aligned with the central axis of the nozzle body.

10. A fuel injector as recited in claim 1, wherein the nozzle body has a central axis and the optical probe is disposed at an angle to the central axis of the nozzle body.

11. A fuel injector as recited in claim 1, wherein each fiber bundles is supported within a respective heat resistant inner guide tube.

12. A fuel injector as recited in claim 1, wherein the plurality of optical fiber bundles are enclosed within a heat resistant outer guide tube.

13. A fuel injector as recited in claim 12, wherein the shaped lens is supported within a heat resistant lens housing mounted at a distal end of the outer guide tube.

14. A system for observing combustion conditions in a gas turbine engine comprising:
a) a nozzle body for issuing fuel into a combustor;
b) an optical probe operatively associated with the nozzle body for observing combustor flame radiation; and
c) means for tracking movement of the flame within the combustor based upon observations by the optical probe.

15. A system as recited in claim 14, wherein the means for tracking flame movement includes an array of fiber optic bundles within the optical probe for receiving flame radiation across a specific space.

16. A system as recited in claim 15, wherein the means for tracking flame movement further includes a detector communicating with the array of fiber optic bundles for detecting flame radiation received by the each of the fiber optic bundles.

17. A system as recited in claim 16, wherein the means for tracking flame movement further includes a comparator for comparing the flame radiation detected by each of the fiber optic bundles.

18. A method of controlling combustion in a gas turbine engine, comprising the steps of:
a) detecting flame radiation received by a plurality of optical detectors located within the combustion chamber of a gas turbine engine;
b) determining which of the plurality of optical detectors observed the greatest intensity of flame radiation within the combustion chamber; and
c) selecting flame data obtained from the optical detector that observed the greatest intensity of flame radiation to control combustion in the gas turbine engine.

19. A method according to claim 18, wherein the step of selecting data obtained from the optical detector that observed the greatest intensity of flame radiation includes selecting chemiluminescent spectral data from said optical detector.

20. A method according to claim 18, further comprising the step of tracking the position of a flame based upon a comparison of the intensity of flame radiation observed by each of the plurality of optical detectors.

21. A method according to claim 20, further comprising the step of utilizing the position of the flame as data for controlling combustion.

22. A method of diagnosing a defective fuel injector in a gas turbine engine comprising the steps of:
a) providing a fuel injector with an optical probe for observing a combustor flame emanating from the fuel injector; and
b) detecting a pattern of radiation within the combustor flame indicative of a defective fuel injector.

23. A method according to claim 22, wherein the step of detecting a pattern of radiation includes the step of observing a pattern of relatively low flame intensity.

24. A method according to claim 22, wherein the step of detecting a pattern of radiation includes the step of observing a pattern of relatively high flame intensity.
